(19) United States
(12) Patent Application Publication
(10) Pub. No.: US 2024/0076462 A1
(43) Pub. Date: Mar. 7, 2024

(54) POLYURETHANE FOAMS FOR REDUCING CORROSION OF POLYMERIC MATERIALS

(71) Applicant: BASF SE, Ludwigshafen Am Rhein (DE)

(72) Inventors: Chen SHEN, Shanghai (CN); Yu Xiang ZHOU, Shanghai (CN); Jian DING, Shanghai (CN); YingHao LIU, Shanghai (CN)

(21) Appl. No.: 18/262,218

(22) PCT Filed: Jan. 17, 2022
(86) PCT No.: PCT/EP22/50899

§ 371 Date: Jul. 20, 2023

(30) Foreign Application Priority Data
Feb. 3, 2021 (WO) PCT/CN2021/075053

(51) Int. Cl. C08J 9/00; C08G 18/18; C08G 18/20; C08G 18/32; C08G 18/48; C08G 18/66; C08G 18/76

(52) U.S. Cl. CPC C08J 9/0023; C08G 18/1833; C08G 18/2027; C08G 18/3206; C08G 18/4816; C08G 18/6674; C08G 18/7671; C08G 2101/00; C08G 2110/0083

(57) ABSTRACT

Disclosed herein are polyurethane foams which can be used for reducing or preventing the corrosion of polymeric materials, which can be produced by mixing components (a) at least one polyisocyanate, (b) at least one compound having at least two groups reactive toward isocyanates, (c) optionally chain extender and/or crosslinking agent, (d) blowing agent, (e) catalyst, (f) optionally auxiliaries and additives, and (g) at least one anhydride to give a reaction mixture, and curing said reaction mixture to give the polyurethane foams, where the anhydride is added in an amount of 0.05-5 wt %, based on the weight of component (a). Also disclosed herein are a method of reducing or preventing the corrosion of polymeric materials by using such polyurethane foams and a method of using the polyurethane foams in certain applications, for example, in automotive interiors.

### TECHNICAL FIELD

The present invention relates to polyurethane foams which can be used for reducing or preventing the corrosion of polymeric materials. The present invention also relates to the method of reducing the corrosion of polymeric materials via the abovementioned polyurethane foams and the use of such polyurethane foams in certain applications, for examples, in automotive interiors.

### BACKGROUND

Polyurethane foams are suitable for a large number of applications, for example cushioning materials, thermal insulation materials, packaging materials, automobile-dashboards, or construction materials. Polyurethane foams, for example, when used in automotive interiors, can be applied to constitute parts of steering wheel, acoustic system, seats, trim panel, etc. In these applications, the polyurethane foams are frequently in contact with other materials, such as polyesters or polycarbonates (PC). Certain ingredients or reactants used in preparing the polyurethane foams may be present as residues in the final foam products and inevitably leak out into the environment in practical use. Some amine compounds, which might be used as, for example, catalyst for preparing polyurethanes, frequently leak out of the foams and penetrate into the adjoining polyesters or polycarbonates. Those amine compounds may have catalytic effect on these polymeric materials and thus cause corrosion or degradation thereof. The corrosion or degradation of those polymeric materials results in discoloration and crack of the automotive parts or even dysfunction thereof.

Thus, it is needed in the art that new polyurethane foams should be prepared, which substantially reduce the corrosion or degradation of polymeric materials when used together in certain applications. Such need has not been fulfilled so far.

### SUMMARY OF THE PRESENT INVENTION

One object of the present invention is to provide polyurethane foams that may reduce or prevent corrosion or degradation of polymeric materials when used together. This object is fulfilled by polyurethane foams which is obtainable or obtained by mixing the following components
(a) at least one polyisocyanate
(b) at least one compound having at least two hydrogen atoms reactive toward isocyanates,
(c) optionally chain extender and/or crosslinking agent,
(d) blowing agent,
(e) catalyst,
(f) optionally auxiliaries and additives, and
(g) at least one anhydride to give a reaction mixture, and reacting said reaction mixture to give the polyurethane foam, wherein the anhydride is added in an amount of 0.05-5 wt %, based on the weight of component (a).

In an embodiment, the anhydride is added in an amount of 0.1-3 wt %, preferably 0.25-2 wt %, based on the weight of component (a).

In an embodiment, the anhydride is selected from linear or cyclic, saturated or unsaturated, aromatic or aliphatic C4-C24-carboxylic anhydrides or -dicarboxylic anhydrides that could be dispersed or dissolved in the isocyanates.

In a further embodiment, the anhydride is selected from linear or cyclic C4-C24-alkenyl succinic anhydride, including, but not limited to, dodecenyl succinic anhydride, nonenyl succinic anhydride; methyl norbornene-2,3-dicarboxylic anhydride; 2,2-dimethyl glutaric anhydride; 1,8-naphthalic anhydride; 3,4,5,6-tetrahydrophthalic anhydride; 3-methylglutaric anhydride; decanoic anhydride; crotonic anhydride.

In an embodiment, the polyurethane foams are produced by mixing component (A) comprising (b), optionally (c), (d), (e) and optionally (f), with component (B) comprising (a) and (g) to give a reaction mixture, and reacting said reaction mixture.

In a further embodiment, the blowing agent includes water or is exclusively water.

In a further embodiment, the catalyst comprises amine-based catalyst.

The present invention also relates to a method for reducing corrosion of polymeric materials, which includes subjecting the polymeric materials into contact with the polyurethane foams according to the present invention.

The present invention further relates to use of said polyurethane foams for reducing corrosion of polymeric materials.

Compared with conventional polyurethane foams, the inventive polyurethane foams can be used directly in contact with polymeric materials, such as polycarbonates or other polyesters (PBT, PET etc.) in, for example, automotive interiors, such as steering wheel, seats, trim panel, etc. and surprisingly find it is substantially less or even no corrosion or degradation can be seen on the surface of the polymeric materials.

### BRIEF DESCRIPTION OF THE DRAWINGS

FIG. 1 shows photos of PC plates before being put in contact with polyurethane foams and being heated in oven under 120° C. for 7 days.

FIG. 2 shows photos of PC plates after being put in contact with polyurethane foams prepared without anhydride or with 0.5 parts of nonenylsuccinic anhydride and being heated in oven under 120° C. for 7 days.

FIG. 3 shows photos of PC plates after being put in contact with polyurethane foams containing different contents of nonenylsuccinic anhydride.

FIG. 4 shows photos of PET plates after being put in contact with polyurethane foams prepared without anhydride (left) and with 0.5% of DDSA (right).

FIG. 5 shows photoshop analysis of the photos in FIG. 4 using mosaic filter to show the percentage of yellowing area.

### DETAILED DESCRIPTION OF THE PRESENT INVENTION

Unless defined otherwise, all technical and scientific terms used herein have the meaning commonly understood by a person skilled in the art to which the invention belongs. As used herein, the following terms have the meanings ascribed to them below, unless specified otherwise.

As used herein, the articles “a” and “an” refer to one or to more than one (i.e., to at least one) of the grammatical object of the article. By way of example, “an element” means one element or more than one element.

As used herein, the term “about” is understood to refer to a range of numbers that a person of skill in the art would consider equivalent to the recited value in the context of achieving the same function or result.

As used herein, the term “additives” refers to additives included in a formulated system to enhance physical or chemical properties thereof and to provide a desired result. Such additives include, but are not limited to, dyes, pigments, toughening agents, impact modifiers, rheology modifiers, plasticizing agents, thixotropic agents, natural or synthetic rubbers, filler agents, reinforcing agents, thickening agents, inhibitors, fluorescence or other markers, thermal degradation reducers, thermal resistance conferring agents, surfactants, wetting agents, defoaming agents, dispersants, flow or slip aids, biocides, and stabilizers.

Unless otherwise identified, all percentages (%) are “percent by weight”.

The radical definitions or elucidations given above in general terms or within areas of preference apply to the end products and correspondingly to the starting materials and intermediates. These radical definitions can be combined with one another as desired, i.e. including combinations between the general definition and/or the respective ranges of preference and/or the embodiments.

All the embodiments and the preferred embodiments disclosed herein can be combined as desired, which are also regarded as being covered within the scope of the present invention.

Unless otherwise identified, the temperature refers to room temperature and the pressure refers to ambient pressure.

Unless otherwise identified, the solvent refers to all organic and inorganic solvents known to the persons skilled in the art and does not include any type of monomer molecular.

The present invention is directed to polyurethane foams which can be produced by mixing the following components
(a) at least one polyisocyanate,
(b) at least one compound having at least two hydrogen atoms reactive toward isocyanates,
(c) optionally chain extender and/or crosslinking agent,
(d) blowing agent,
(e) catalyst,
(f) optionally auxiliaries and additives, and
(g) at least one anhydride to give a reaction mixture, and reacting said reaction mixture to give the polyurethane foam, wherein the anhydride is added in an amount of 0.05-5 wt %, based on the weight of component (a).

(a) Polyisocyantes

The polyisocyanates (a) used for producing the polyurethane foams according to the invention comprise all polyisocyanates known for the production of polyurethanes. These comprise the aliphatic, cycloaliphatic and aromatic divalent or polyvalent isocyanates known from the prior art and any desired mixtures thereof. Aliphatic diisocyanates used are customary aliphatic and/or cycloaliphatic diisocyanates, for example tri-, tetra-, penta-, hexa-, hepta- and/or octamethylene diisocyanate, 2-methylpentamethylene 1,5-diisocyanate, 2-ethyltetramethylene 1,4-diisocyanate, hexamethylene 1,6-diisocyanate (HDI), pentamethylene 1,5-diisocyanate, butylene 1,4-diisocyanate, trimethylhexamethylene 1,6-diisocyanate, 1-isocyanato-3,3,5-trimethyl-5-isocyanatomethylcyclohexane (isophorone diisocyanate, IPDI), 1,4- and/or 1,3-bis(isocyanatomethyl)cyclohexane (HXDI), cyclohexane 1,4-diisocyanate, 1-methylcyclohexane 2,4- and/or 2,6-diisocyanate, methylene dicyclohexyl 4,4′-, 2,4′- and/or 2,2′-diisocyanate (H12M DI). Suitable aromatic diisocyanates are especially naphthylene 1,5-diisocyanate (NDI), tolylene 2,4- and/or 2,6-diisocyanate (TDI), 3,3′-dimethyl-4,4′-diisocyanatodiphenyl (TODD, p-phenylene diisocyanate (PDI), diphenylethane 4,4′-diisocyanate (EDI), diphenylmethane diisocyanate, dimethyl diphenyl 3,3′-diisocyanate, diphenylethane 1,2-diisocyanate and/or diphenylmethane diisocyanates (MDI).

Polyisocyanates (a) preferably used herein are the aromatic polyisocyanates which are readily obtainable in industry, particularly preferably mixtures of diphenylmethane diisocyanates (MDI) and of polyphenyl polymethylene polyisocyanates.

The polyisocyanates (a) may also be employed in the form of polyisocyanate prepolymers. These polyisocyanate prepolymers are obtainable by reacting an excess of the above-described polyisocyanates (constituent (a-1)) with polymeric compounds having isocyanate-reactive groups (constituent (a-2)) and/or chain extenders (constituent (a-3)) for example at temperatures of 20° C. to 100° C., preferably at about 80° C., to afford the isocyanate prepolymer.

Polymeric compounds having isocyanate-reactive groups (a-2) and chain extenders (a3) are known to those skilled in the art and described for example in “Kunststoffhandbuch [Plastics Handbook], volume 7, Polyurethane [Polyurethanes]”, Carl Hanser Verlag, 3rd edition 1993, chapter 3.1.

(b) Compound having at least two hydrogen atoms reactive toward isocyanates Compounds having at least two hydrogen atoms reactive toward isocyanates (b) used here can be any of the compounds used known for polyurethane production and having at least two reactive hydrogen atoms and having a molar mass of at least 500 g/mol. The functionality of these is by way of example from 2 to 8, with a molecular weight of from 400 to 12 000. By way of example, it is therefore possible to use polyether polyamines and/or polyols selected from the group of the polyether polyols, polyester polyols, polycarbonate polyols or a mixture thereof.

The polyols preferably used are polyetherols and/or polyesterols with molecular weights of between 500 and 12 000, preferably from 500 to 6000, and preferably of average functionality from 2 to 6, preferably from 2 to 4.

The polyetherols that can be used in the present invention are produced by known processes. By way of example, they can be produced via anionic polymerization using alkali metal hydroxides, e.g. sodium hydroxide or potassium hydroxide, or using alkali metal alcoholates, e.g. sodium methanolate, sodium ethanolate or potassium ethanolate, or potassium isopropanolate, as catalysts, and with addition of at least one starter molecule which has from 2 to 8, preferably from 2 to 6, reactive hydrogen atoms, or via cationic polymerization using Lewis acids, such as antimony pentachloride, boron fluoride etherate, etc., or bleaching earth, as catalysts. Polyether polyols can likewise be produced via double-metal-cyanide catalysis, from one or more alkylene oxides having from 2 to 4 carbon atoms in the alkylene moiety. It is also possible to use tertiary amines as catalyst, an example being triethylamine, tributylamine, trimethylamine, dimethylethanolamine, imidazole, or dimethylcyclohexylamine. It is also possible, for specific intended uses, to incorporate monofunctional starters into the structure of the polyether.

Examples of suitable alkylene oxides are tetrahydrofuran, propylene 1,3-oxide, butylene 1,2- or 2,3-oxide, styrene oxide, and preferably ethylene oxide and propylene 1,2-oxide. The alkylene oxides can be used individually, in alternating succession, or in the form of a mixture.

Examples of starter molecules that can be used are: water, aliphatic and aromatic, optionally N-mono-, or N,N- or N,N′-dialkyl-substituted diamines having from 1 to 4 carbon atoms in the alkyl moiety, for example optionally mono- and dialkyl-substituted ethylenediamine, diethylenetriamine, triethylenetetramine, 1,3-propylenediamine, 1,3- or 1,4-butylenediamine, 1,2-, 1,3-, 1,4-, 1,5-, and 1,6-hexamethylenediamine, phenylenediamine, 2,3-, 2,4-, and 2,6-tolylenediamine (TDA), and 4,4′-, 2,4′-, and 2,2′-diaminodiphenylmethane (MDA), and polymeric MDA. Other starter molecules that can be used are: alkanolamines, e.g. ethanolamine, N-methyl-, and N-ethylethanolamine, dialkanolamines, e.g. diethanolamine, N-methyl-, and N-ethyldiethanolamine, trialkanolamines, e.g. triethanolamine, and ammonia. It is preferable to use polyhydric alcohols, such as ethanediol, 1,2- and 2,3-propanediol, diethylene glycol, dipropylene glycol, 1,4-butanediol, 1,6-hexanediol, glycerol, trimethylolpropane; pentaerythritol, sorbitol, and sucrose, and mixtures thereof. The polyether polyols can be used individually or in the form of a mixture.

Polyesterols are produced by way of example from alkanedicarboxylic acids and from polyhydric alcohols, polythioetherpolyols, polyesteramides, hydroxylated polyacetals, and/or hydroxylated aliphatic polycarbonates, preferably in the presence of an esterification catalyst. Other possible polyols are given by way of example in “Kunststoffhandbuch, Band 7, Polyurethane” [Plastics Handbook, volume 7, Polyurethanes], Carl Hanser Verlag, 3rd edition 1993, chapter 3.1.

The polyesterols used with preference can by way of example be produced from dicarboxylic acids having from 2 to 12 carbon atoms, preferably from 4 to 6 carbon atoms, and from polyhydric alcohols. Examples of dicarboxylic acids that can be used are: aliphatic dicarboxylic acids, such as succinic acid, glutaric acid, adipic acid, suberic acid, azelaic acid, and sebacic acid, and aromatic dicarboxylic acids, such as phthalic acid, isophthalic acid, and terephthalic acid. The dicarboxylic acids can be used individually or in the form of mixtures, e.g. in the form of a mixture of succinic, glutaric, and adipic acid. It can optionally be advantageous for producing the polyesterols to use, instead of the dicarboxylic acids, the corresponding dicarboxylic acid derivatives, such as dicarboxylic esters having from 1 to 4 carbon atoms in the alcohol moiety, dicarboxylic anhydrides, or diacyl chlorides. Examples of polyhydric alcohols are glycols having from 2 to 10, preferably from 2 to 6, carbon atoms, e.g. ethylene glycol, diethylene glycol, 1,4-butanediol, 1,5-pentanediol, 1,6-hexanediol, 1,10-decanediol, 2,2-dimethyl-1,3-propanediol, 1,3-propanediol, and dipropylene glycol, triols having from 3 to 6 carbon atoms, e.g. glycerol and trimethylolpropane, and, as higher-functionality alcohol, pentaerythritol. The polyhydric alcohols can be used alone or optionally in mixtures with one another, in accordance with the properties desired. In preparing the polyurethane foams of the invention, it is preferable to use polyetherols as compounds (b) having at least two hydrogen atoms reactive toward isocyanates. It is particularly preferable that these comprise at least one di- to trifunctional polyoxyalkylene polyol (b1) having a hydroxy number of from 20 to 40 and having a proportion greater than 70% of primary hydroxy groups. The polyoxyalkylene polyol (b1) preferably comprises at least 50% by weight of propylene oxide, particularly preferably at least 80% by weight.

In particular for producing the inventive polyurethane foams, it is possible to use, alongside the polyoxyalkylene polyol (b1), a polyoxyalkylene polyol (b2) which has a functionality of from 2 to 4, a hydroxy number of from 25 to 60, a proportion greater than 70% of primary OH groups, preferably greater than 80%, based in each case on the total number of OH groups, and an ethylene oxide content which is preferably at least 50% by weight, particularly preferably from 60% by weight to 95% by weight.

Another material used to produce the inventive polyurethane foams is at least one di- to tetrahydric polyoxyalkylene polyol (b3) having a hydroxy number of from 150 to 650 and a proportion greater than 80% of primary hydroxy groups, where the polyhydroxy compound (b3) preferably comprises at least 30% by weight of ethylene oxide, particularly preferably at least 50% by weight. In an embodiment, polyols (b1)-(b3) can be used together as the component (b). The proportion of the component (b1) is preferably from 15 to 35% by weight, that of the component (b2) is preferably from 15 to 35% by weight, and that of the component (b3) is preferably from 20 to 35% by weight, in each case based on the total weight of the component (b).

(c) Optionally Chain Extender and/or Crosslinking Agent

Chain extenders and/or crosslinking agents (c) that can be used are substances having a molar mass which is preferably smaller than 500 g/mol, particularly preferably from 60 to 400 g/mol, where chain extenders have two hydrogen atoms reactive toward isocyanates and crosslinking agents have three hydrogen atoms reactive toward isocyanate. These can be used individually or preferably in the form of a mixture. It is preferable to use diols and/or triols having molecular weights smaller than 500, particularly from 60 to 400, and in particular from 60 to 350. Examples of those that can be used are aliphatic, cycloaliphatic, and/or araliphatic diols having from 2 to 14, preferably from 2 to 10, carbon atoms, e.g. ethylene glycol, 1,3-propanediol, 1,4-butanediol, 1,6-hexanediol, 1,10-decanediol, and bis(2-hydroxyethyl)hydroquinone, 1,2-, 1,3-, and 1,4-dihydroxycyclohexane, diethylene glycol, dipropylene glycol, tripropylene glycol, triols, such as 1,2,4- or 1,3,5-trihydroxycyclohexane, glycerol, and trimethylolpropane, and low-molecular-weight hydroxylated polyalkylene oxides based on ethylene oxide and/or on propylene 1,2-oxide, and on the abovementioned diols and/or triols, as starter molecules. It is particularly preferable to use, as crosslinking agents (c), low-molecular-weight hydroxylated polyalkylene oxides based on ethylene oxide and/or on propylene 1,2-oxide, particularly preferably on ethylene and on trifunctional starters, in particular glycerol.

The proportion of chain extender and/or crosslinking agent (c), based on the weight of component (b), if these are present, is preferably from 1 to 35% by weight, particularly preferably from 3 to 25% by weight, and in particular from 5 to 15% by weight.

(d) Blowing Agent

The blowing agent (d) used here can be any blowing agent known in the art that can be suitably used in preparation of polyurethane foams. Preferably, the blowing agent (d) comprises blowing agent containing water. The blowing agent (d) used can also comprise, as well as water, well-known compounds having chemical and/or physical effect. Chemical blowing agents are compounds which form gaseous products through reaction with isocyanate, an example being water or formic acid. Physical blowing agents are compounds which have been dissolved or emulsified in the starting materials for polyurethane production and which vaporize under the conditions of polyurethane formation. By way of example, these are hydrocarbons, halogenated hydrocarbons, and other compounds, such as perfluorinated alkanes, e.g., perfluorohexane, fluorochlorocarbons, and ethers, esters, ketones and/or acetals, examples being (cyclo)aliphatic hydrocarbons having from 4 to 8 carbon atoms, or fluorocarbons such as Solkane® 365 mfc from Solvay Fluorides LLC. In one preferred embodiment, water as sole blowing agent is used as blowing agent (d).

In one preferred embodiment, the content of the blowing agent is from 0.1 to 10% by weight, preferably from 0.2 to 9% by weight, particularly preferably from 0.3 to 7% by weight, based on the weight of component (b).

(e) Catalyst

Catalysts (e) greatly accelerate the reaction of the component (b) and optionally chain-extending and crosslinking agents (c) and blowing agents (d) with the polyisocyanates (a). The catalysts (e) preferably comprise amine-based catalysts.

Typical catalysts employable for production of polyurethanes include for example amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane, and alkanolamine compounds such as triethanolamine, triisopropanolamine, N-methyl- and N-ethyldiethanolamine and dimethylethanolamine. Likewise contemplated are organic metal compounds, preferably organic tin compounds, such as tin(II) salts of organic carboxylic acids, for example tin(II) acetate, tin(II) octoate, tin(II) ethylhexoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof. The organic metal compounds may be used either alone or preferably in combination with strongly basic amines. If the component (b) is an ester, it is preferable to employ exclusively amine catalysts.

Amine-based catalysts have at least one, preferably 1 to 8 and particularly preferably 1 to 2 groups reactive toward isocyanates, such as primary amine groups, secondary amine groups, hydroxyl groups, amides or urea groups, preferably primary amine groups, secondary amine groups, hydroxyl groups. Amine-based amine catalysts are mostly used for production of low-emission polyurethanes especially employed in automobile interiors. Such catalysts are known and described for example in EP1888664. These comprise compounds which, in addition to the isocyanate-reactive group(s), preferably comprise one or more tertiary amino groups. At least one of the tertiary amino groups in the incorporable catalysts preferably bears at least two aliphatic hydrocarbon radicals, preferably having 1 to 10 carbon atoms per radical, particularly preferably having 1 to 6 carbon atoms per radical. It is particularly preferable when the tertiary amino groups bear two radicals independently selected from methyl and ethyl radical plus a further organic radical. Examples of amine-based catalysts that may be used are bis(dimethylaminopropyl)urea, bis(N,N-dimethylaminoethoxyethyl) carbamate, dimethylaminopropylurea, N, N, N-trimethyl-N-hydroxyethylbis(aminopropylether), N,N,N-trimethyl-N-hydroxyethylbis(aminoethylether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol), (1,3-bis(dimethylamino)propan-2-ol), N, N-bis(3-dimethylaminopropyl)-N-isopropanolamine, bis(dimethylaminopropyI)-2-hydroxyethylamine, N, N, N-trimethyl-N-(3-aminopropyl)-bis(aminoethylether), 1,4-diazabicyclo[2.2.2]octane-2-methanol and 3-dimethylaminoisopropyl diisopropanolamine or mixtures thereof.

Catalysts (e) may be employed for example in a content of 0.005 to 5 wt %, preferably 0.01 to 3 wt %, more preferably 0.05-2 wt %, based on the total weight of the component (b). In a particularly preferred embodiment, exclusively amine-based catalysts are employed as catalysts (e).

(f) Auxiliaries and Additives

Auxiliaries and additives (f) that can be used comprise foam stabilizers, flame retardants, cell openers, surfactants, reaction retardants, stabilizers with respect to aging effects and weathering effects, plasticizers, fungistatic and bacteriostatic substances, pigments and dyes, and also the conventional organic and inorganic fillers known per se.

The foam stabilizers used preferably comprise silicone-based foam stabilizers. The foam stabilizers used can also comprise siloxane-polyoxyalkylene copolymers, organopolysiloxanes, ethoxylated fatty alcohols, and alkylphenols, and castor oil esters and, respectively, ricinoleic esters.

Examples of cell openers are paraffins, polybutadienes, fatty alcohols, and dimethylpolysiloxanes.

The stabilizers used with respect to aging and weathering effects mostly comprise antioxidants. By way of example, these can be sterically hindered phenols, HALS stabilizers (hindered amine light stabilizer), triazines, benzophenones, and benzotriazoles.

Examples of surfactants that can be used are compounds which serve to promote homogenization of the starting materials and ensure phase stability of the polyol component over prolonged periods. These are, optionally, also suitable for regulating cell structure. Mention may be made by way of example of emulsifiers, such as the sodium salts of castor oil sulfates, or of fatty acids, and also salts of fatty acids with amines, e.g. diethylamine oleate, diethanolamine stearate, diethanolamine ricinoleate, salts of sulfonic acids, e.g. the alkali metal or ammonium salts of dodecylbenzene- or dinaphthylmethanedisulfonic acid and ricinoleic acid; foam stabilizers, such as siloxane-oxalkylene copolymers and other organopolysiloxanes, ethoxylated alkylphenols, ethoxylated fatty alcohols, paraffin oils, castor oil esters and, respectively, ricinoleic esters, Turkey red oil, and peanut oil, and cell regulators, such as paraffins, fatty alcohols, and dimethylpolysiloxanes. Other suitable compounds for improving emulsifying effects, or cell structure, and/or for stabilizing the foam are oligomeric polyacrylates having polyoxyalkylene and fluoroalkane radicals as pendent groups.

The amounts usually used of the surfactants, based on the weight of the compound (b), are usually from 0.01 to 5% by weight.

Fillers that can be added, in particular reinforcing fillers, comprise the materials known per se which are conventional organic and inorganic fillers, reinforcing agents, and weighting agents. In detail, examples that may be mentioned are: inorganic fillers, e.g., silicatic minerals, for example phyllosilicates, such as antigorite, serpentine, hornblendes, amphiboles, chrysotile, zeolites, talc; metal oxides, e.g. kaolin, aluminum oxides, aluminum silicate, titanium oxides, and iron oxides, metal salts, e.g. chalk, barite, and inorganic pigments, such as cadmium sulfide, zinc sulfide, and also glass particles. Examples of organic fillers that can be used are: carbon black, melamine, collophony, cyclopentadienyl resins, and polymer-modified polyoxyalkene polyols.

Flame retardants used include flame retardants which comprise expandable graphite and which comprise oligomeric organophosphorus flame retardant. Expandable graphite is well known. This comprises one or more expandable materials, so that considerable expansion takes place under the conditions present in a fire. Expandable graphite is produced by known processes. The usual method here begins by modifying graphite with oxidants, such as nitrates, chromates, or peroxides, or via electrolysis, in order to open the crystal layers, and nitrates or sulfates are then intercalated into the graphite, and can bring about expansion under given conditions. The oligomeric organophosphorus flame retardant preferably comprises no less than 5% by weight of phosphorus content, with the presence of at least 3 phosphate ester units in preferred embodiments. “Phosphorus ester units” here comprise phosphate ester units and phosphonate ester units. The oligomeric organophosphorus flame retardants of the invention therefore comprise structures having pure phosphonate units, having pure phosphate units, and also having phosphonate units and phosphate units.

It is possible to use one or more arbitrary flame retardant(s) usually used, alongside the oligomeric organophosphorus flame retardants and expandable graphite, for polyurethanes. These comprise halogen-substituted phosphates, such as tricresyl phosphate, tris(2-chloroethyl) phosphate, tris(2-chloropropyl) phosphate, tris(1,3-dichloropropyl) phosphate, tris(2,3-dibromopropyl) phosphate, and tetrakis(2-chloroethyl) ethylene diphosphate, and/or inorganic flame retardants, such as red phosphorus, aluminum oxide hydrate, antimony trioxide, arsenic oxide, ammonium polyphosphate, and calcium sulfate, and/or cyanuric acid derivatives, e.g. melamine. It is preferable that the flame retardants comprise no compounds having halogen groups.

Further information concerning the mode of use and of action of the abovementioned auxiliaries and additives, and also further examples, are given by way of example in “Kunststoffhandbuch, Band 7, Polyurethane” [“Plastics handbook, volume 7, Polyurethanes”], Carl Hanser Verlag, 3rd edition 1993, chapter 3.4.

(g) Anhydride

Anhydrides used here can be any carboxylic anhydrides conventionally known in polyurethane industry. These anhydrides include linear or cyclic, saturated or unsaturated, aromatic or aliphatic C4-C24-carboxylic anhydrides or -dicarboxylic anhydrides that can be suitably dispersed or dissolved in the isocyanates, or the mixture thereof. Examples that can be mentioned include acetic anhydride, propionic anhydride, butyric anhydride, isobutyric anhydride, valeric anhydride, isovaleric anhydride, pivalic anhydride, lauric anhydride, myristic anhydride, palmitic anhydride, stearic anhydride, malonic anhydride, succinic anhydride, glutaric anhydride, adipic anhydride, pimelic anhydride, suberic anhydride, azelaic anhydride, sebacic anhydride, malic anhydride, tartaric anhydride, racemic anhydride, tartronic anhydride, or mesoxalic anhydride. Particularly, anhydrides that can be mentioned here comprise linear or cyclic, saturated or unsaturated, aromatic or aliphatic C4-C20-carboxylic anhydrides or -dicarboxylic anhydrides that are liquid and having molar mass of less than 600 g/mol. Preferred anhydrides are linear or cyclic C4-C24-alkenyl succinic anhydride, including, for example, dodecenyl succinic anhydride, nonenyl succinic anhydride; methyl norbornene-2,3-dicarboxylic anhydride, 2,2-dimethyl glutaric anhydride; 1,8-naphthalic anhydride; 3,4,5,6-tetrahydrophthalic anhydride; 3-methylglutaric anhydride; decanoic anhydride; crotonic anhydride.

In an embodiment, the anhydride (g) is mixed with the polyisocyanate (a) to form component B, and then is mixed with other components to give a reaction mixture. Anhydride (g) can be added in an amount of 0.05-5 wt %, preferably 0.5-3 wt %, based on the weight of component (a).

Preparation of Polyurethane Foams

The amounts of polyisocyanates (a), compounds (b) having at least two hydrogen atoms reactive toward isocyanates, optionally chain extenders and/or crosslinking agents (c), blowing agents (d), catalysts (e), optionally auxiliaries and additives (f) are preferably mixed such that the isocyanate index is in the range from 60 to 400, particularly preferably from 80 to 150. The isocyanate index during production of the polyurethane foams is preferably from 95 to 130, particularly preferably from 98 to 118. When calculating the isocyanate index, anhydride (g) is not counted in.

For the purposes of the present invention, this isocyanate index is the stoichiometric ratio of isocyanate groups to groups reactive toward isocyanate, multiplied by 100. Groups reactive toward isocyanate here are any of the groups which are present in the reaction mixture and which are reactive toward isocyanate, inclusive of chemical blowing agents, but not the isocyanate group itself.

The polyurethane foams of the invention are preferably produced by the one-shot process in the form of large foam slabs, continuously in slab-foam systems, or batchwise in open foam molds. If a mixing chamber with a plurality of inlet nozzles is used, the starting components can be introduced individually and mixed intensively in the mixing chamber. It has proven particularly advantageous to use two-component process and to use, as what is known as component A, a mixture from the mixing of the compounds (b) having at least two hydrogen atoms reactive toward isocyanates, optionally chain extenders and/or crosslinking agents (c), blowing agents (d), catalysts (e), and optionally auxiliaries and additives (f), and to use, as what is known as component B, a mixture from the mixing of the polyisocyanates (a) and anhydride (g). Since the A and B components have very good shelf life, they can easily be transported in this form, and all that is required prior to processing is then that the appropriate amounts be intensively mixed. High-pressure or low-pressure processing systems can be used to mix structural components (a) to (g), or components (A) and (B).

The polyurethane foams of the present invention are produced by mixing the starting materials described, advantageously in the form of components A and B, at temperatures of about 15 to 60° C., preferably 20 to 40° C., and then permitting the reaction mixture to foam in open, optionally temperature-controlled molds, or in continuously operating slab-foam systems.

The densities of the resultant polyurethane foams depend on the amount of blowing agent used and are from 50 to 500 g/L, preferably from 100 to 450 g/L, and particularly preferably from 250 to 350 g/L. At the same time, the products exhibit very good hydrolysis resistance.

From the resultant polyurethane foam slabs it is possible, if necessary, to cut foam slabs dimensioned in accordance with the molding to be produced, and to split these to give PU foam sheets of thickness from 1 to 50 mm, preferably from 2 to 30 mm, and in particular from 5 to 20 mm. Any of the conventional industrial splitting devices is suitable for this purpose, but in practice it is preferable to use horizontal splitting systems with circulating band knife.

In the preparation, the anhydride is preferably mixed together with the polyisocyanates (a) firstly to form component B, and then is mixed with other components. This will avoid the side reaction between anhydride and water as blowing agent to the maximum content.

Reducing Corrosion of Polymeric Materials

The polyurethane foams of the present invention thus prepared can be used in many application fields. For example, the inventive polyurethane foams can be used in automotive interiors, such as steering wheel, seating, auto sunroof, auto carpet, trim panel, or used in home appliances, leisure goods, or furniture. In these applications, the polyurethane foams are constantly in contact with other polymeric materials, such as polycarbonates or other polyesters. Certain ingredients, especially amine-based catalyst, leak out from the polyurethane foams, penetrate into the adjoining polymeric materials and may have catalytic effect on the corrosion or degradation thereof. Consequently, the polymeric materials used in automotive interiors would suffer a lot of damages, such as cracks, discoloration or even dysfunction, upon contact with polyurethane foams. By using the polyurethane foams of the present invention, such corrosion of polymeric materials can be greatly reduced or even prevented, and significantly less corrosion or even no corrosion can be seen from the surface of the polymeric materials. The polymeric materials can be conventionally used polymeric materials, including, but not limited to, aromatic PC, aliphatic-aromatic PC, or copolymers of PC with other polymeric materials, such as PC/PE, PC/HDPE, or other polyesters such as PBT, PET etc.

### EXAMPLES

The present invention will now be described with reference to Examples and Comparative Examples, which are not intended to limit the present invention.

The following starting materials were used:
Isocyanate A: Elastan 4510/102/1 C-B, 4,4′-MDI, commercially available from BASF.
Polyol 1: glycerol initiated polyetherol with OH number of 35 mg KOH/g, Mw of about 4800.
Polyol 2: glycerol initiated polyetherol with OH number of 42 mg KOH/g, Mw of about 4000.
Polyol 3: glycerol initiated polyetherol with OH number of 28 mg KOH/g, Mw of about 4000.
Catalyst 1: Bis(2-dimethylaminoethyl) ether, CAS No. 3033-62-3, commercially available from Envonik.
Catalyst 2: 1,4-Diazabicyclo[2.2.2]octane, CAS No. 280-57-9, commercially available from Evonik.
Ethylene glycol: commercially available from Sinopec.
Anhydride 1: Nonenylsuccinic anhydride, commercially available from TRIGON.
Anhydride 2: Dodecenyl Succinic anhydride (DDSA), CAS No. 25377-73-5, commercially from Vertellus

Measurement Methods:

Density of the foam is determined in accordance with DIN EN ISO 1183-1, A. Corrosion area calculation method: The corrosion area of the samples is analyzed by photoshop area color analysis, which is detailed in the following procedure.

### Example 1

The polyurethane foams were obtained by the following procedure: mixing 86 parts by weight of polyol 1, 2.5 parts by weight of polyol 2, 12 parts by weight of polyol 3, 8 parts by weight of ethylene glycol, 0.8 part by weight of Catalyst 1, 0.8 parts by weight of Catalyst 2, and 0.5 parts by weight of water to give a component A; mixing component A with component B comprising 100 parts of isocyanate A and 0.05 parts of nonenylsuccinic anhydride as indicated in Table 1 to give a reaction mixture; and curing the reaction mixture under 40° C. for 6 hours in a mold (50 cm×50 cm×10 cm) to give a polyurethane foam. The isocyanate index used here was 102.

### Comparative Example 1

The same procedure was repeated as in Example 1, except that no anhydride was added in the component B. Polyurethane foams with identical size were obtained.

### Examples 2-5

In these examples, the same procedure was repeated as in Example 1, except that the anhydride was added in the amount as indicated in table 1 for each example.

The evaluation of the corrosion grade was conducted as follows:
1. Preparing identical PC plates using polycarbonates (purchased as Covestro 2407) for the PU foams prepared in each example. These PC plates were 14 cm long, 2 cm at the maximum width and 1.2 cm at the minimum width, and 0.5 cm thick.
2. Cutting PU foams into foam sheets of 5 cm×2 cm×1 cm, and putting these PU foam sheets on the PC plates.
3. Heating these PC plates and the polyurethane foams placed thereon together in an oven under 120° C. for 7 days.
4. Taking the pictures of the samples obtained above and analyzing them with Photoshop. Mosaic filter was introduced to turn the pictures to mosaic only with color. Counting the area of yellowing mosaic in the pictures of the samples, and calculating the percentage of yellowing area (i.e., the number of the yellowing mosaic) on the basis of the whole area of the sample (i.e., the number of the mosaic of the whole sample). This percentage number calculated is defined as corrosion grade, in %.

The results were summarized in the following table 1.

TABLE 1

| Amount (parts by | Comparative | Example | Example | Example | Example | Example |
|---|---|---|---|---|---|---|
| weight) | example 1 | 1 | 2 | 3 | 4 | 5 |
| Component A | | | | | | |
| Polyol 1 | 86 | 86 | 86 | 86 | 86 | 86 |
| Polyol 2 | 2.5 | 2.5 | 2.5 | 2.5 | 2.5 | 2.5 |
| Polyol 3 | 12 | 12 | 12 | 12 | 12 | 12 |
| Ethylene glycol | 8 | 8 | 8 | 8 | 8 | 8 |
| Catalyst 1 | 0.8 | 0.8 | 0.8 | 0.8 | 0.8 | 0.8 |
| Catalyst 2 | 0.8 | 0.8 | 0.8 | 0.8 | 0.8 | 0.8 |
| Water | 0.5 | 0.5 | 0.5 | 0.5 | 0.5 | 0.5 |
| Component B | | | | | | |
| Elastan 4510/102/1 | 100 | 100 | 100 | 100 | 100 | 100 |
| C-B | | | | | | |
| Nonenylsuccinic | 0 | 0.05 | 0.25 | 0.5 | 2.0 | 5 |
| anhydride | | | | | | |
| Index | 102 | 102 | 102 | 102 | 102 | 102 |
| Density- DIN EN ISO | 350 | 350 | 350 | 350 | 350 | 350 |
| 1183-1 [g/l] | | | | | | |
| PC Plate Corrosion | 53.7 | 22.2 | 11.1 | 5.5 | 0 | 0 |
| Grade (%) | | | | | | |

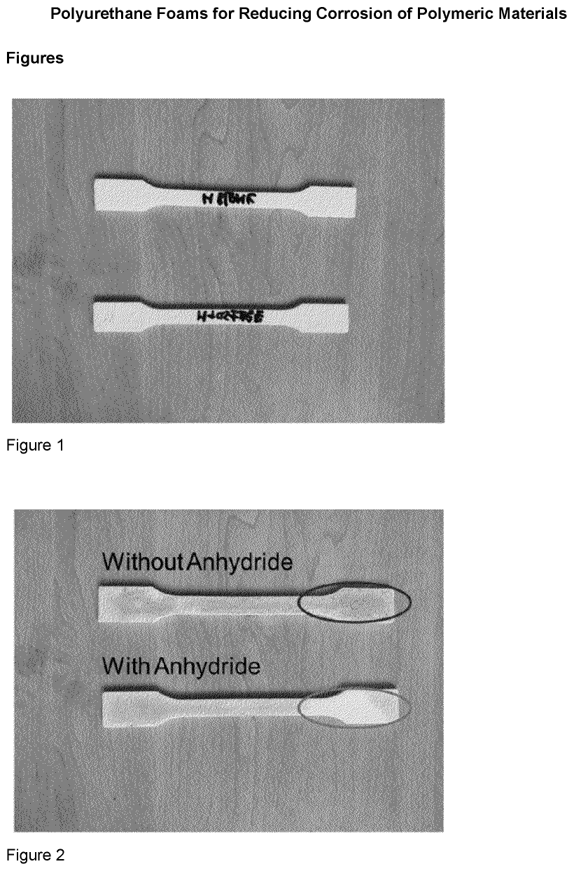

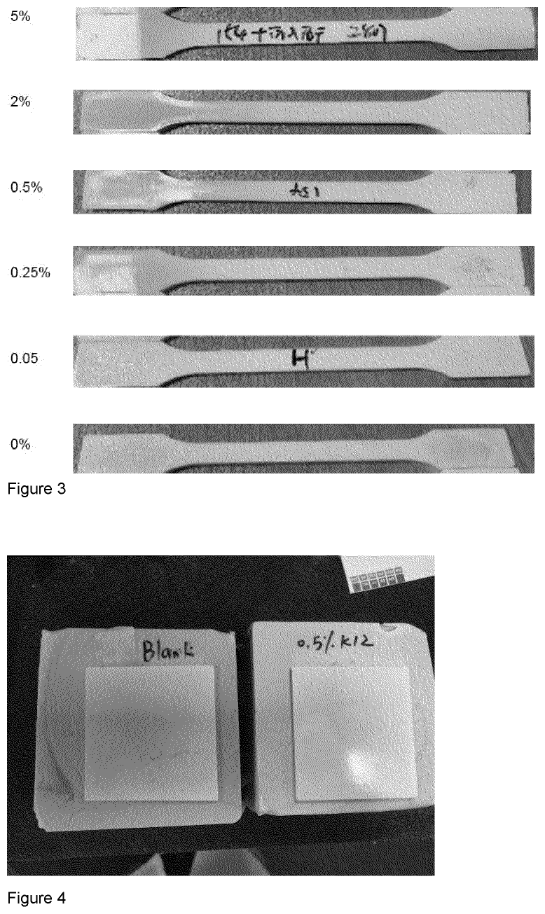

After heating together in an oven under 120° C. for 7 days, the corrosion of these PC plates were analyzed and obviously different appearances could be seen by bare eyes (see FIGS. 1 and 2). As shown in FIGS. 1 and 2, PC plate in contact with comparative PU foam (prepared with no anhydride) shows appearance of obvious corrosion on the whole surface. In contrast, on the right part of PC plate in contact with inventive PU foam prepared with 0.5 parts of anhydride, a clean appearance with almost no corrosion could be seen clearly. Indeed, as can be seen from the above table, the corrosion grade of the PC plates in contact with the inventive PU foams show significantly reduced corrosion or even basically no corrosion. It is indicated that the polyurethane foams according to the present invention have substantial effect in reducing corrosion of polycarbonates when they are put into contact with each other. With the increasing content of anhydride, the corrosion grade of the PC plates decreases, as shown in FIG. 3. When the content of anhydride is high enough, basically no corrosion can be seen on the surface of the PC plate.

### Examples 6-8

In these examples, the same procedure was repeated as in Example 1, except that dodeceny succinicanhydride (DDSA) was used instead of nonenylsuccinic anhydride. The components and added amounts thereof were listed in the following table 2.

### Comparative Example 2

The same procedure was repeated as in examples 6-8, except that no anhydride was added in the component B.

The evaluation of the corrosion grade of the PU foams prepared in comparative example 2 and examples 6-8 was conducted in the same manner as stated above, except that the plates in contact with these PU foams were PET plates instead of PC plates. The results were summarized in the following table 2.

TABLE 2

| Amount (parts | Comparative | Example | Example | Example |
|---|---|---|---|---|
| by weight) | example 2 | 6 | 7 | 8 |
| Component A | | | | |
| Polyol 1 | 86 | 86 | 86 | 86 |
| Polyol 2 | 2.5 | 2.5 | 2.5 | 2.5 |
| Polyol 3 | 12 | 12 | 12 | 12 |
| Ethylene glycol | 8 | 8 | 8 | 8 |
| Catalyst 1 | 0.8 | 0.8 | 0.8 | 0.8 |
| Catalyst 2 | 0.8 | 0.8 | 0.8 | 0.8 |
| Water | 0.5 | 0.5 | 0.5 | 0.5 |
| Component B | | | | |
| Elastan 4510/102/1 | 100 | 100 | 100 | 100 |
| C-B | | | | |
| DDSA | 0 | 0.5 | 1.0 | 1.5 |
| Index | 102 | 102 | 102 | 102 |
| Density- DIN EN ISO | 350 | 350 | 350 | 350 |
| 1183-1 [g/l] | | | | |
| PET Plate Corrosion | 100 | 12.5 | 7.3 | 6.2 |
| Grade (%) | | | | |

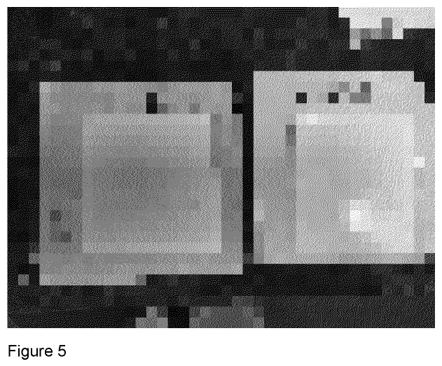

As can be seen from the above table, similar effects in terms of reducing corrosion of the polymeric materials can be obtained in examples 6-8 as in the above examples 1-5, when PC plates were changed to PET plates. The corrosion grade of PTE plates was significantly reduced when the PU foam prepared with certain amounts of anhydride was used in replace of the PU foam with no anhydride, as also shown in FIGS. 4 and 5.

### Example 9

In example 9, the same procedure was repeated as in examples 6-8, except that dodeceny succinicanhydride (DDSA) was added in the amount as listed in the following table 3.

### Comparative Example 3

The same procedure was repeated as in example 9, except that no anhydride was added in the component B.

The evaluation of the corrosion grade of the PU foams prepared in comparative example 3 and example 9 was conducted in the same manner as stated above, except that the plates in contact with these PU foams were PBT plates. The results were summarized in the following table 3.

TABLE 3

| | Comparative | |
|---|---|---|
| Amount (parts by weight) | example 3 | Example 9 |
| Component A | | |
| Polyol 1 | 86 | 86 |
| Polyol 2 | 2.5 | 2.5 |
| Polyol 3 | 12 | 12 |
| Ethylene glycol | 8 | 8 |
| Catalyst 1 | 0.8 | 0.8 |
| Catalyst 2 | 0.8 | 0.8 |
| Water | 0.5 | 0.5 |
| Component B | | |
| Elastan 4510/102/1 C-B | 100 | 100 |
| DDSA | 0 | 0.5 |
| Index | 102 | 102 |
| Density- DIN EN ISO 1183-1 [g/l] | 350 | 350 |
| PBT Plate Corrosion Grade (%) | 100 | 14.2 |

Again, similar effects can be seen from the comparison between example 9 and comparative example 3 in reducing the corrosion of PBT plates. The corrosion grade of PBT plate in contact with PU foam prepared by certain amount of anhydride (example 9) was significantly lower than that of comparative PU foam with no anhydride (comparative example 3).

The structures, materials, compositions, and methods described herein are intended to be representative examples of the invention, and it will be understood that the scope of the invention is not limited by the scope of the examples. Those skilled in the art will recognize that the invention may be practiced with variations on the disclosed structures, materials, compositions and methods, and such variations are regarded as within the ambit of the invention. Thus, it is intended that the present invention cover such modifications and variations as come within the scope of the appended claims and their equivalents.

1. Polyurethane foams obtainable or obtained by mixing the following components
(a) at least one polyisocyanate,
(b) at least one compound having at least two hydrogen atoms reactive toward isocyanates,
(c) optionally chain extender and/or crosslinking agent,
(d) blowing agent,
(e) catalyst,
(f) optionally auxiliaries and additives, and
(g) at least one anhydride
to give a reaction mixture, and reacting said reaction mixture to give the polyurethane foams wherein the anhydride is added in an amount of 0.05-5 wt %, based on the weight of component (a).

2. The polyurethane foams according to claim 1, wherein the anhydride is present in an amount of 0.1-3 wt %, based on the weight of component (a).

3. The polyurethane foams according to claim 1, wherein the anhydride is selected from the group consisting of linear or cyclic, saturated or unsaturated, and aromatic or aliphatic C4-C24-carboxylic anhydrides or -dicarboxylic anhydrides that could be dispersed or dissolved in the isocyanates.

4. The polyurethane foams according to claim 1, wherein the anhydride is selected from the group consisting of linear or cyclic, saturated or unsaturated, and aromatic or aliphatic C4-C20-carboxylic anhydrides or -dicarboxylic anhydrides that are liquid and have a molar mass of less than 600 g/mol.

5. The polyurethane foams according to claim 1, wherein the anhydride is selected from the group consisting of dodecenyl succinic anhydride, nonenyl succinic anhydride, methyl norbornene-2,3-dicarboxylic anhydride, 2,2-dimethyl glutaric anhydride; 1,8-naphthalic anhydride; 3,4,5,6-tetrahydrophthalic anhydride; 3-methylglutaric anhydride; decanoic anhydride; and crotonic anhydride.

6. The polyurethane foams according to claim 1, wherein component (a) is selected from the group consisting of n-hexylisocyanate, cyclohexylisocyanate, hexamethylene isocyanate, 2-ehtyl hexylisocyanate, n-octyl isocyanate, deodecyl-isocyanate, stearylisocyanate, benzyl isocyanate, diphenylmethane 4,4″-diisocyanate, diphenylmethane 2,4″-diisocyanate, mixtures of monomeric diphenylmethane diisocyanates with diphenylmethane diisocyanate homologs having a larger number of rings (polymer MDI), tetramethylene diisocyanate, hexamethylene diisocyanate (HDI), mixtures of hexamethylene diisocyanates with oligomeric or polymeric homologs of hexamethylene diisocyanate (polynuclear HDI), isophorone diisocyanate (IPDI), tolylene 2,4- or 2,6-diisocyanate (TDI), and mixtures of two or more of these isocyanates.

7. The polyurethane foams according to claim 1, wherein component (b) is selected from the group consisting of polyether polyamines and/or polyols, wherein the polyols are selected from the group consisting of the polyether polyols, polyester polyols, polycarbonate polyols and a mixture thereof.

8. The polyurethane foams according to claim 1, wherein the blowing agent comprises water.

9. The polyurethane foams according to claim 1, wherein the catalyst comprises amine-based catalyst.

10. The polyurethane foams according to claim 1, wherein the polyurethane foams are produced by mixing component (A) comprising (b), optionally (c), (d), (e) and optionally (f), with component (B) comprising (a) and (g) to give a reaction mixture, and reacting said reaction mixture.

11. The polyurethane foams according to claim 10, wherein component A and component B are mixed such that the isocyanate index is in the range of from 60 to 400.

12. A method for reducing or preventing corrosion of polymeric materials, which comprises subjecting the polymeric materials into being in contact with the polyurethane foams obtainable or obtained according to claim 1.

13. The method according to claim 12, wherein the polymeric materials comprise polycarbonates and polyesters.

14. A method of using the polyurethane foams obtainable or obtained according to claim 1, the method comprising using the polyurethane foams for reducing or preventing corrosion of polymeric materials.

15. The method of using the polyurethane foams according to claim 14, wherein the polyurethane foams and polymeric materials are used in automotive interiors, home appliances, leisure goods, or furnitures.

16. The polyurethane foams according to claim 1, wherein the anhydride is present in an amount of 0.25-2 wt %, based on the weight of component (a).

17. The polyurethane foams according to claim 1, wherein the blowing agent comprises exclusively water.

18. The polyurethane foams according to claim 10, wherein component A and component B are mixed such that the isocyanate index is in the range of from 98 to 118.
